(19) United States
(12) Patent Application Publication
(10) Pub. No.: US 2012/0005499 A1
(43) Pub. Date: Jan. 5, 2012

(54) Power Control System and Method

(76) Inventor: Vijayan Chomatil, Tucson, AZ (US)

(21) Appl. No.: 12/828,291

(22) Filed: Jul. 1, 2010

(51) Int. Cl. G06F 1/32

(52) U.S. Cl. 713/320

(57) ABSTRACT

A power block is provided having a plurality of individually, remotely controlled power ports switchable between an on state and an off state which users may connect electronic devices. The power block determines the desired power state for the particular power port that a particular electronic device is connected based on infrared codes used to power on or off the particular electronic device and switches the port between the on or off state accordingly.

### FIELD OF THE INVENTION

The invention relates in general to a method and apparatus for controlling power supplied to electrical equipment. More particularly the present invention is related to a power control system and method of controlling power to a group of switchable electrical slave outlets to energize and de-energize equipment connected thereto

### BACKGROUND OF THE INVENTION

It is common for almost every electronic device to be found within three states power consumption. The first state is one in which the device is not connected to a power source. The second state is one in which the device is connected to a power source, yet the electronic device is not powered on. The third state is one in which the device is connected to a power source, and the device is powered on. The difference between states one and two as they relate to power consumption is that in state one the amount of power consumed by the device is zero. In state two a small amount of power is being consumed by the device. This second state can also be referred to as sleep mode or one in which the device can resume typical operation and function in a short amount of time.

Household electronic devices will remain in the second state for a majority of their remaining useful life. The cost to power an electronic device in this slow drain state can be significant and for many electronic devices can exceed $30 per year. One reason devices remain in this state is that to disconnect power from the electronic device requires physically disconnecting the device from the power source.

Most electronic devices come with a remote utilizing infrared, blue tooth, radio frequency, or equivalent wireless protocol to communicate with the electronic device at a distance. Remotes are extremely convenient for powering an electronic device on or off, however they do not address the problem of completely powering off an electronic device thereby reducing its power consumption to zero. A device which can leverage the components within existing electronic devices and the accompanying remote to reduce power consumption to zero when the device is powered off but still connected the a power source can yield significant savings.

### SUMMARY OF THE INVENTION

In accordance with these needs, a controlling device referred to as a power block is disclosed having programming which ensures a connected electronic device will be placed into the desired power state. The power block determines the desired power state for the port connecting an electronic device based on infrared codes used to power on or off the connected electronic device.

An apparatus according to at least one embodiment is provided that includes a connection to a power source; a plurality of power ports, each of the power ports switchable between an on state and an off state, wherein in an on state power from the power source is supplied to electronic equipment connected to a power port and in an off state power from the power source is not supplied to the electronic equipment connected to the power port; a receiver, the apparatus operable therewith to receive a code from a remote control device and therewith switch each of the power ports individually between the on state and the off state; and a controller, the apparatus operable therewith to determine whether a code received from the remote control device is associated with a particular power port and to switch the particular power port between states a predetermined time after receiving the code from the remote control device.

The apparatus may also include a memory that stores codes for controlling a plurality of electronic devices. In this instance, the controller is operable therewith to evaluate the code received against the codes stored on the memory and to switch a particular power port between states based on a particular electronic device being connected to the particular power port and the code received.

The memory may further store a delay associated with each of a plurality of electronic devices. The controller may be operable to switch the particular power port between states in the predetermined time after receiving the code according to the delay associated with the particular electronic device connected to the particular power port.

In at least one embodiment, the apparatus includes a state machine that determines at least one of a state of a particular power port and whether an electronic device connected to the particular power port is turned on or off. In this instance, the controller is operable to switch the particular power port to the off state in response to receiving the code for controlling the particular electronic device connected to the particular power port when at least one of the particular power port is in the on state and the particular electronic device connected to the particular power port is turned on.

The code received may be associated with a particular type of electronic device. In this instance, at least one of the power ports of the apparatus and the particular electronic device are both controlled with the code received, and the controller is operable to switch the power port to the off state the predetermined time after receiving the code.

The apparatus may also include a state machine that determines at least one of a state of a particular power port and whether an electronic device connected to the particular power port is turned on or off. In this instance, the controller is operable to switch the particular power port to the on state in response to receiving the code for controlling the particular electronic device connected to the particular power port when at least one of the particular power port is in the off state and the particular electronic device connected to the particular power port is turned off.

The code received may be associated with a particular type of electronic device. In this instance, at least one of the power ports of the apparatus and the particular electronic device are both controlled with the code received, and the controller is operable to switch the power port to the on state with the code received.

The apparatus may also include a transmitter, the apparatus operable therewith to transmit a code to control the particular electronic device connected to the particular power port. In this instance, the controller is operable to transmit the code for controlling the particular electronic device and therewith turn the particular electronic device on a predetermined time after the particular power port is switched to the on state.

The code transmitted to turn the particular electronic device on may be a minor or the same code received that turns the particular power port to the on state.

In at least one embodiment, an apparatus is provided that includes a connection to a power source; a plurality of power ports, each of the power ports switchable between an on state and an off state, wherein in an on state power from the power source is supplied to electronic equipment connected to a power port and in an off state power from the power source is not supplied to the electronic equipment connected to the power port; a receiver, the apparatus operable therewith to receive a code from a remote control device and therewith switch each of the power ports individually between the on state and the off state; a memory that stores codes for controlling a plurality of electronic devices and a delay associated with each of the plurality of electronic devices, and a controller, the apparatus operable therewith to determine whether a code received from the remote control device is associated with a particular power port and to switch the particular power port from an on state to an off state a predetermined time after receiving the code from the remote control device according to the delay associated with the particular electronic device connected to the particular power port.

The code received may be associated with a particular type of electronic device. In this instance, at least one of the power ports of the apparatus and the particular electronic device are both controlled with the code received.

The controller may be operable to switch the particular power port to the on state in response to receiving the code for controlling the particular electronic device connected to the particular power port when at least one of the particular power port is in the off state and the particular electronic device connected to the particular power port is turned off. The controller may also be operable to switch the power port to the on state with the code received.

The apparatus may include a transmitter, the apparatus operable therewith to transmit a code to control the particular electronic device connected to the particular power port. In this instance, the controller may be operable to transmit the code for controlling the particular electronic device and therewith turn the particular electronic device on a predetermined time after the particular power port is switched to the on state.

The code transmitted to turn the particular electronic device on may be a minor or the same code received that turns the particular power port to the on state.

### BRIEF DESCRIPTION OF THE FIGURES

FIG. 1 is a diagram of a common system for providing power to common household electronic devices;

FIG. 2 is a functional block diagram of an inventive power block management system for reducing the cost to power electronic devices according to one embodiment;

FIG. 3 is a functional block diagram of an inventive power block management system for reducing the cost to power electronic devices according to an alternate embodiment;

FIG. 4 is a functional block diagram of an inventive power block management system for reducing the cost to power electronic devices according to a second alternate;

FIG. 5 is a state machine illustrating the operation of permitting or eliminating power to a connected electronic device on a power block port according to one embodiment;

FIG. 5a is a flow chart illustrating the operation of a state machine to control the inventive power block for powering on connected electronic devices;

FIG. 5a is a state machine illustrating the operation of permitting power to a connected electronic device on a power block port according to one embodiment;

FIG. 5a is a state machine illustrating the operation of eliminating power to a connected electronic device on a power block port according to one embodiment;

FIG. 6 is a detailed diagrammatic view of data flow in an inventive power block according to one embodiment;

FIG. 7 is a state machine illustrating the operation of updating a power block with infrared codes to

### DETAILED DESCRIPTION OF THE INVENTION

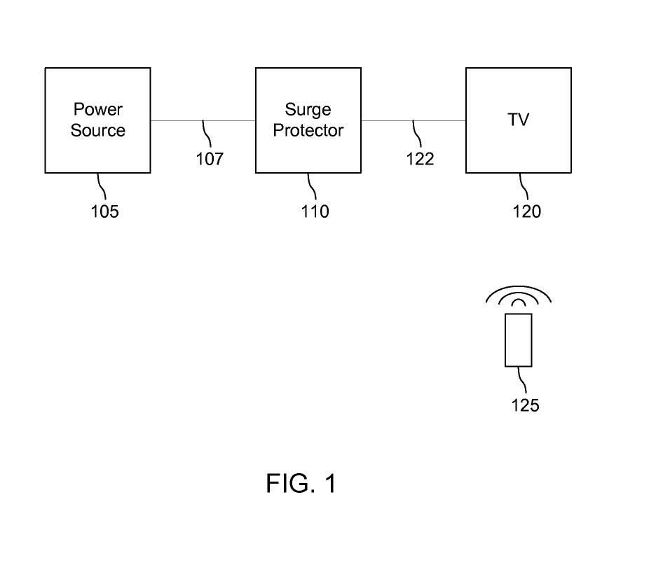

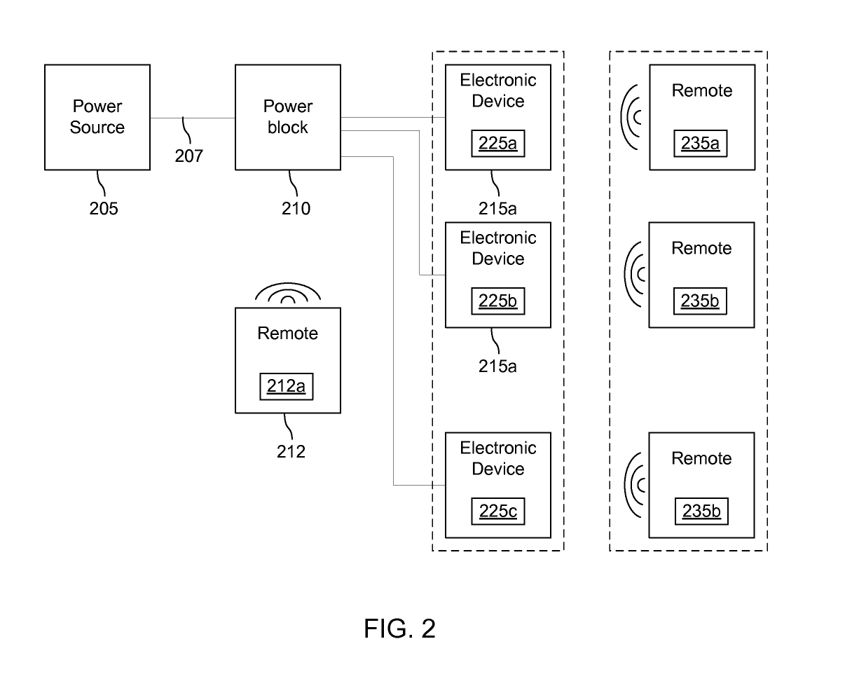

FIG. 1 is a diagram of a common system for providing power to common household electronic devices. A power source 105 is connected to a surge protector 110 via a power cable 107. Power source 105 is operable to provide alternating current (AC) for the operation of electronic devices. Surge protector 110 is operable to prevent voltage spikes that exceed the operating voltage of an electronic device connected to surge protector 110 which would cause significant damage to an electronic device connected directly to power source 105. Surge protector 110 is connected to a television 120 (herein referred to as TV) via a power cable 122. TV 120 is an electronic device that's primary function is to display video when connected to a video source. A remote 125 is operable to communicate with TV 120 at a distance.

During normal operation of TV 120 of FIG. 1 a user (not shown) may power TV 120 off by utilizing a power button 125a on remote 125. This method for powering on/off TV 120 does not actually cut the power to TV 120. A measurement taken at a point along power cable 122 would indicate a small amount of power well below the operational level of TV 120, but significant enough to increase the cost to power TV 120. A cost to power household electronic devices equation is the product of power consumed and the rate charged per unit of power for each electronic device j.

$${\sum }_{j = 1}^{n} ( {\int }_{{t}_{0}}^{{t}_{f}} {I}_{j} ( t ) \cdot {V}_{j} ( t ) d t ) \cdot r$$

The cost to power household electronic devices equation increases as a result of power usage increasing. Referring back to FIG. 1 user may also power off TV 120 by disconnected either power cable 107 or power cable 122. This method for powering on/off TV 105 reduces all current to TV as well as effectively reducing the cost to power electronic devices equation to zero for a particular electronic device j to zero.

FIG. 2 is a functional block diagram of an inventive power block management system 200 for reducing the cost to power electronic devices according to one embodiment. A power source 205 is connected to a power block 210 via a power cable 207. Power source 205 is operable to provide alternating current (AC) for the operation of electronic devices. Power block 210 is an electronic device operable to permit or eliminate power to connected electronic devices as determined by a power block state machine 210a. The operation of power block state machine 210a is described below. A power block infrared reader 210b is operable to read infrared codes. A power block remote 212 is operable to control the function of power block 210 at a distance and includes a power block remote transmitter 212a operable to transmit infrared codes to power block 210. Power block 210 is connected via a plurality of power cables 220a-220n to a plurality of electronic devices 215a-215n. Each of the plurality of electronic devices includes an electronic device infrared reader 225a-225n operable to read infrared codes. A plurality of remotes 230a-230n control operation for each of plurality of electronic devices 215a-215n. Control operation is performed via the transmission of infrared codes by a remote infrared code transmitter 235a-235n in each of remotes 230a-230n.

The power block 210 may include a remote receiver (not shown). That is, the power block 210 may be located at a location removed from the electronic device that will be controlled with the power block 210. For example, the power block 210 may be near the floor or inside a television cabinet while the television plugged into the power block is elevated in the television cabinet. This arrangement may prevent the remote transmitter from communicating successfully with the receiver of the power block 210 every time. In this respect, the power block receiver may be coupled to the block with an extension/dongle. This allows the receiver to be placed near the receiver of the electronic device so as to limit the limitations noted above with receivers remote from the electronic device. The remote receiver may also include a transmitter coupled with the extension/dongle to the power block 210 in the event that the power block transmits control signals to the electronic device or devices to similarly unsuccessful communications between the power block and the electronic equipment.

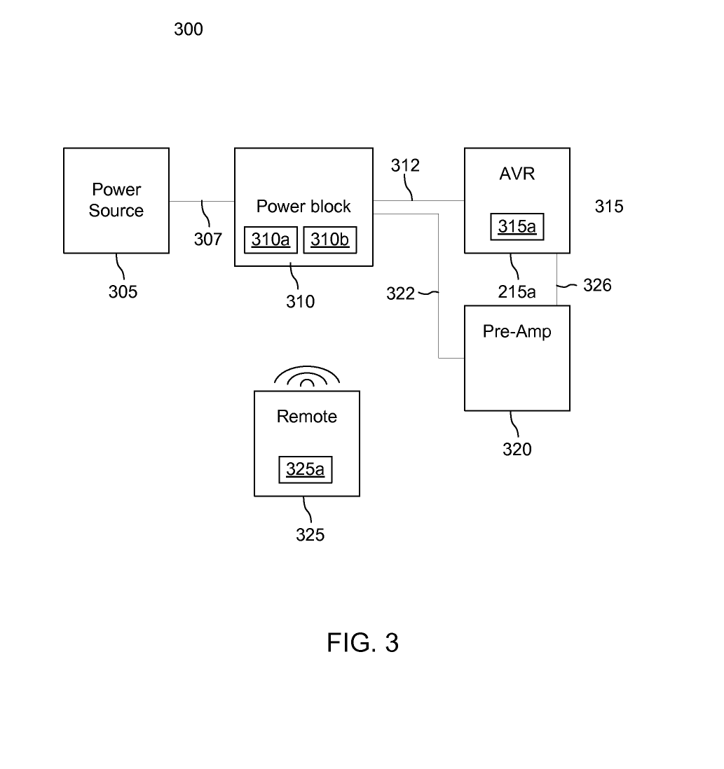

FIG. 3 is a functional block diagram of an inventive power block management system 300 for reducing the cost to power electronic devices according to an alternate embodiment. A power source 305 is connected to a power block 310 via a power cable 307. Power block 310 includes a state machine 310a and an infrared reader 310b. Each of the functional blocks 305, 310, 310a, and 310b is substantially similar in function and operation to blocks 205, 210, 210a, and 210b of FIG. 2. An audio/video receiver 315 (herein referred to as AVR) is connected to power block 310 via a power cable 312. AVR 315 is operable to receive audio and video signals and retransmit them to speakers, television, or any video display device/audio transmission device. AVR 315 includes an AVR infrared reader 315a operable to read infrared codes. An AVR remote 325 operable to control the function of AVR 315 at a distance includes a remote infrared transmitter 325a operable to transmit infrared codes to AVR 315. A pre-amplifier 320 is connected to power block 310 via a power cable 322. Audio signal passed from AVR 315 via an audio cable 326 is processed by pre-amplifier 320.

The function and operation of pre-amplifier 320 is only necessary when AVR 315 is functional and operational. Therefore it is only necessary to power pre-amplifier 320 when AVR 315 is also powered. Both AVR 315 and pre-amplifier 320 are connected to power block 310. Power block management system 300 allows for the nearly simultaneous powering on or off of both AVR 315 and pre-amplifier 320. It is not uncommon for electronic devices to be without an infrared reader and pre-amplifier 320 is described as one such device.

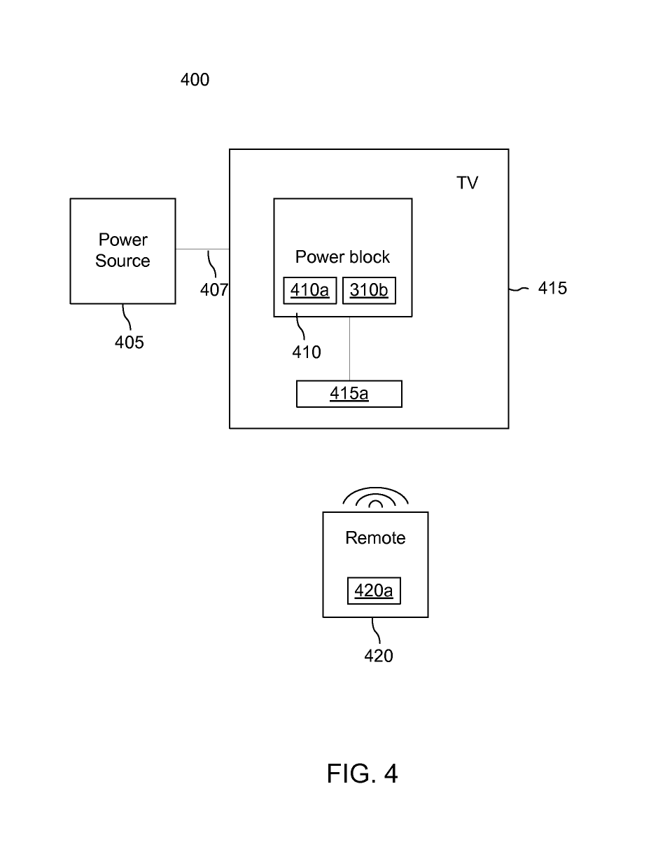

FIG. 4 is a functional block diagram of an inventive power block management system 400 for reducing the cost to power electronic devices according to a second alternate embodiment. A power source 405 is connected via a power cable 407 to a power block module 410 within a television (herein referred to as TV) 415. Power block module 410 includes a state machine 410a. Each of the functional blocks 405, 410, and 410a is substantially similar in function and operation to blocks 205, 210, and 210a of FIG. 2. TV 415 includes a TV infrared reader 415a operable to receive transmitted infrared codes. Also included in power block management system 400 is a TV remote 420 operable to transmit infrared codes via a TV remote infrared transmitter to control TV 415.

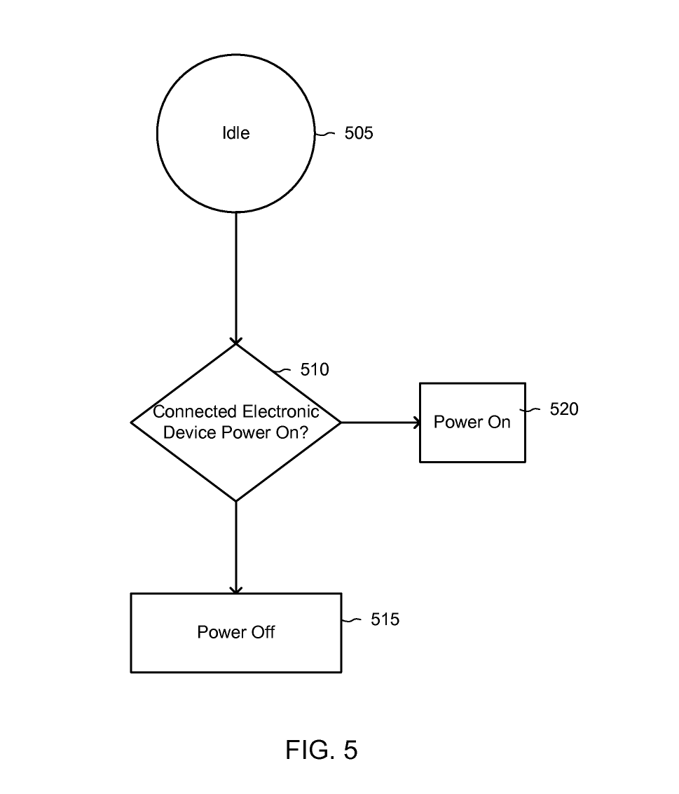

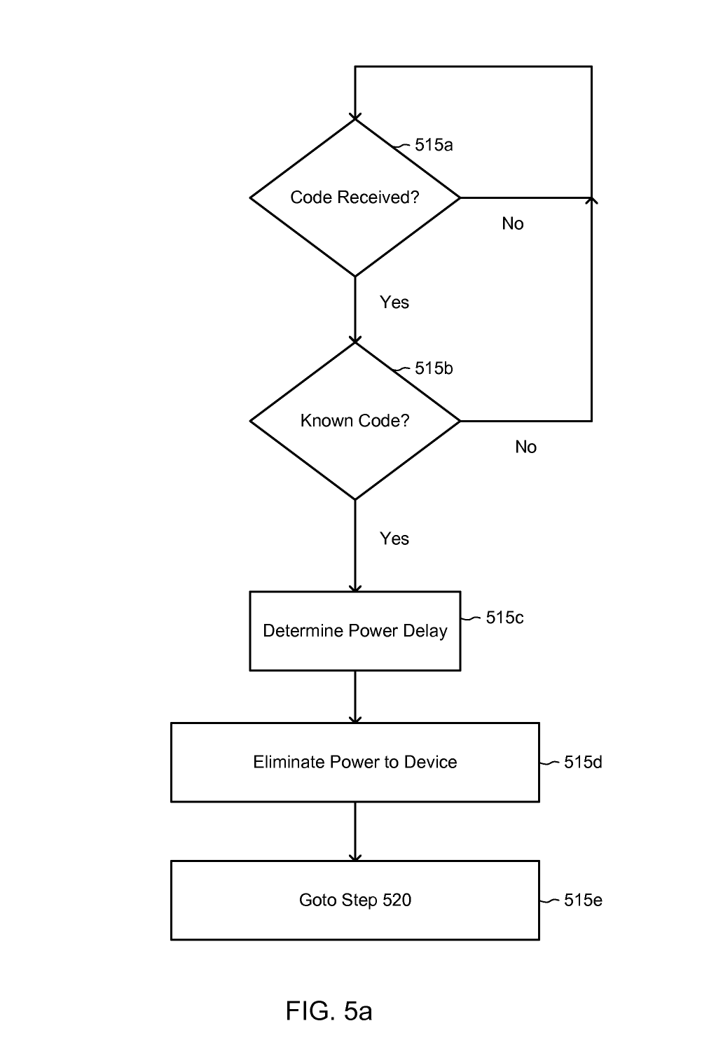

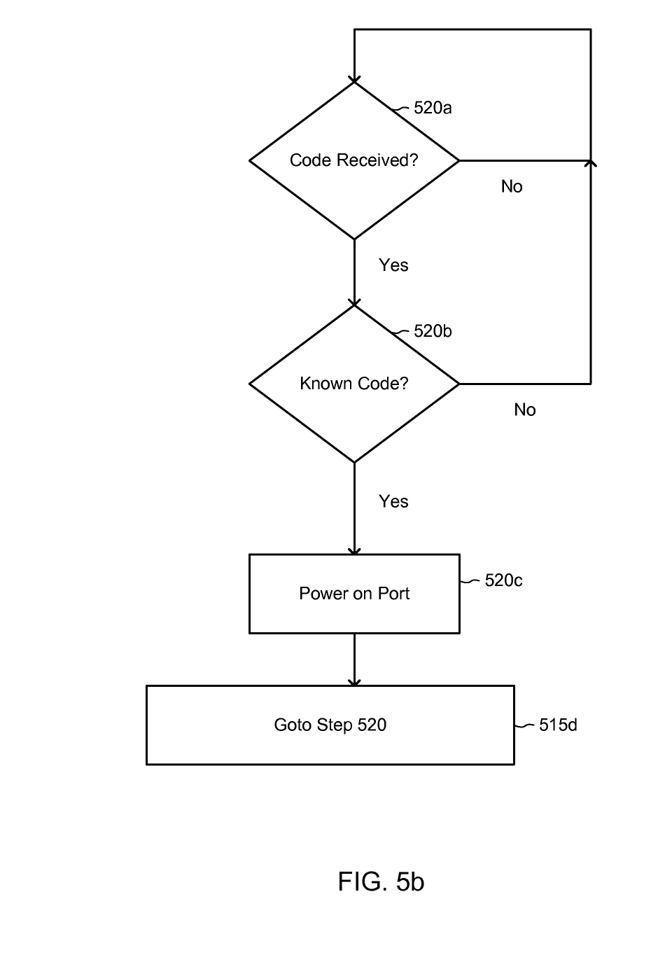

A data and control path 425 (herein refereed to as path) connects TV infrared port 415a and power block module 410. Path 425 provides the infrared codes to power block module 410 in which they are evaluated based on state machine 410a described below on FIG. 5. Incorporating the function of the power block module 410 into an electronic device such as TV 415 leverages the existing TV infrared port 415a to accomplish permitting or eliminating power to an electronic device when it is powered off.

FIG. 5 is a flow diagram illustrating a state machine process for the operation of permitting or eliminating power to a connected electronic device on a power block port according to one embodiment. Beginning at idle step 505, if in a step 510 a connected electronic device is powered on, then in a step 515 the connected electronic device is powered off. Otherwise in a step 520 the connected electronic device is powered on.

FIG. 5a is a state machine illustrating the operation of eliminating power to a connected electronic device on a power block port according to one embodiment. If in a step 515a an infrared code has been received then in a step 515b it is verified if the infrared code is known by comparing to a list of stored infrared codes. Only the infrared codes that refer to powering an electronic device are stored in power block. If in a step 515b the infrared code is known, then in a step 515c a delay is determined. Otherwise the state machine returns to check for infrared codes. The delay determined in step 515c refers to the amount of time power block waits to eliminate power on the port connecting the electronic device desired to be powered off. The delay according to one embodiment is a predetermined time that exceeds the longest time necessary for an electronic device to process the infrared code to power off the electronic device. Recall that both the electronic device and power block receive the infrared code simultaneously. The delay according to an alternate embodiment is specified by the electronic device according to the manufacturer's specification regarding the time necessary to power off the electronic device. Next, in a step 515d power is eliminated on the port connecting the electronic device.

In one embodiment, the power block and/or the transmitter are programmable to communicate a series of control signals to a plurality of devices. For example, the remote and/or the power block may be programmed to power down electronic equipment and the ports that the equipment are plugged into in a particular sequence. For instance, the remote or a button thereon may be programmed to shut the power off on a TV, followed by the power on an A/V device, then the individual ports after the applicable delay.

FIG. 5b is a state machine illustrating the operation of permitting power to a connected electronic device on a power block port according to one embodiment. If in a step 520a an infrared code has been received then in a step 520b it is verified if the infrared code is known by comparing to a list of stored infrared codes. Only the infrared codes that refer to powering an electronic device are stored in power block. If in a step 520b the infrared code is known, then in a step 520c the port connecting the electronic device is powered on. The power block device may mirror the infrared code to the electronic device to turn the device on a predetermined time after the power block port is turned on. Again, the delay time may vary based on the equipment being turned on. The power block may determine the state of the electronic device following transmission of the signal to turn the device on to ensure that the device has been turned on. If not, the power block may repeat the transmission until the device is actually turned on or for a certain number of times.

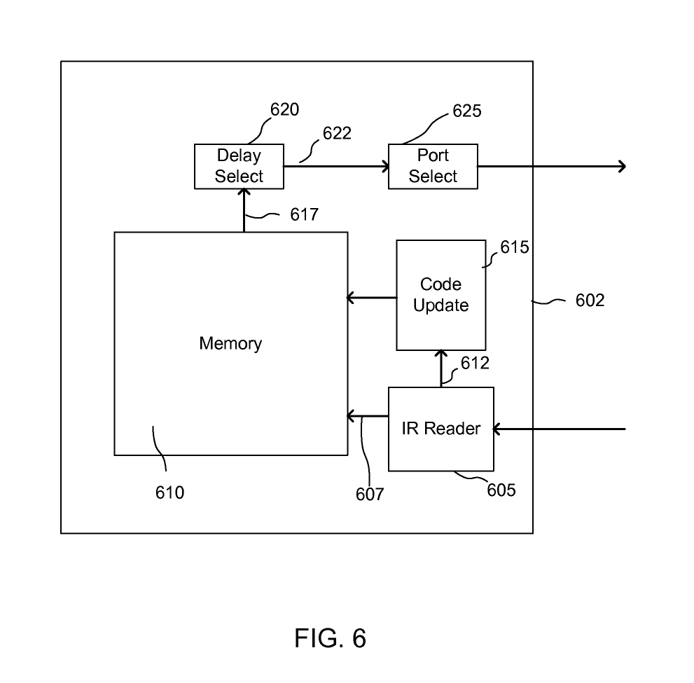

FIG. 6 is a detailed diagrammatic view of data flow in an inventive power block 602 according to one embodiment. Power block infrared reader 605 is connected via a data and control path 607 (herein referred to as path) to a memory 610 operable to store the infrared codes used to power electronic devices. A path 612 from infrared reader 605 is connected to an infrared code update module 615 operable to interface with memory storage 250 for adding or removing infrared codes. Memory 610 is connected via a path 617 to a delay module 620 operable to provide the necessary wait time for permitting or eliminating power to the electronic device connected to power block 602. A path is connected to a port select module 625, which determines from memory 610 which port will permit or eliminate power.

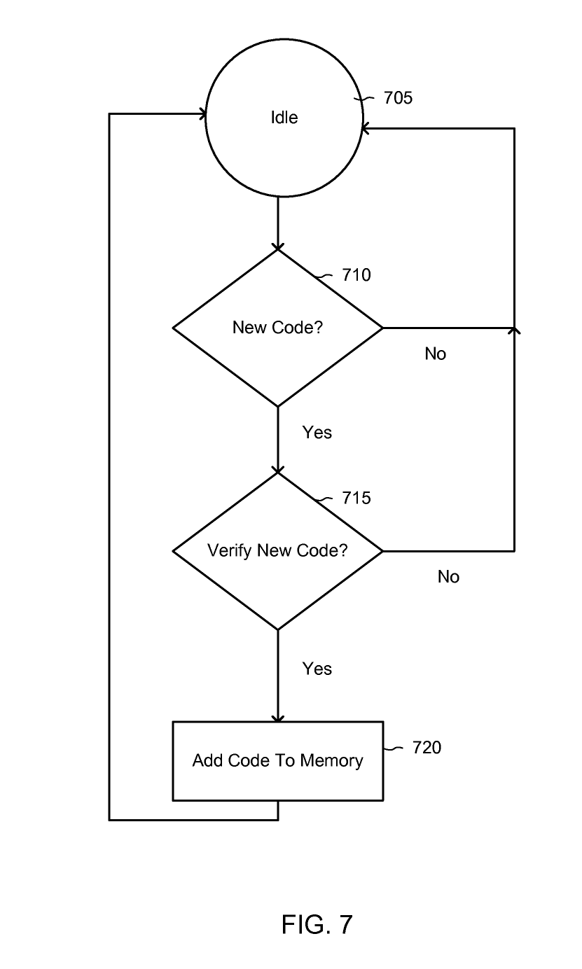

FIG. 7 is a flow chart state machine for updating codes for the operation of updating infrared codes of the power block. Beginning in an idle step 705, if the new infrared code mode has been initialized in a step 710, then in a step 715 the new infrared code is verified to have been received on the power block infrared reader. Otherwise the state machine returns to idle step 705. If in step 710 the new infrared code has been received on the power block infrared reader, then in a step 720 the new infrared code is added to the memory of power block. The new code is preferably assigned to one of a plurality of power ports on the power block.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. An apparatus comprising
a connection to a power source;
a plurality of power ports, each of the power ports switchable between an on state and an off state, wherein in an on state power from the power source is supplied to electronic equipment connected to a power port and in an off state power from the power source is not supplied to the electronic equipment connected to the power port;
a receiver, the apparatus operable therewith to receive a code from a remote control device and therewith switch each of the power ports individually between the on state and the off state; and
a controller, the apparatus operable therewith to determine whether a code received from the remote control device is associated with a particular power port and to switch the particular power port between states a predetermined time after receiving the code from the remote control device.

2. The apparatus of claim 1, the apparatus comprising a memory that stores codes for controlling a plurality of electronic devices, the controller operable therewith to evaluate the code received against the codes stored on the memory and to switch a particular power port between states based on a particular electronic device being connected to the particular power port and the code received.

3. The apparatus of claim 2, wherein the memory further stores a delay associated with each of a plurality of electronic devices and wherein the controller is operable to switch the particular power port between states in the predetermined time after receiving the code according to the delay associated with the particular electronic device connected to the particular power port.

4. The apparatus of claim 3, comprising a state machine that determines at least one of a state of a particular power port and whether an electronic device connected to the particular power port is turned on or off, the controller operable to switch the particular power port to the off state in response to receiving the code for controlling the particular electronic device connected to the particular power port when at least one of the particular power port is in the on state and the particular electronic device connected to the particular power port is turned on.

5. The apparatus of claim 4, wherein the code received is associated with a particular type of electronic device, at least one of the power ports of the apparatus and the particular electronic device are both controlled with the code received, and the controller is operable to switch the power port to the off state the predetermined time after receiving the code.

6. The apparatus of claim 3, comprising a state machine that determines at least one of a state of a particular power port and whether an electronic device connected to the particular power port is turned on or off, the controller operable to switch the particular power port to the on state in response to receiving the code for controlling the particular electronic device connected to the particular power port when at least one of the particular power port is in the off state and the particular electronic device connected to the particular power port is turned off.

7. The apparatus of claim 4, wherein the code received is associated with a particular type of electronic device, at least one of the power ports of the apparatus and the particular electronic device are both controlled with the code received, and the controller is operable to switch the power port to the on state with the code received.

8. The apparatus of claim 7, comprising a transmitter, the apparatus operable therewith to transmit a code to control the particular electronic device connected to the particular power port, wherein the controller is operable to transmit the code for controlling the particular electronic device and therewith turn the particular electronic device on a predetermined time after the particular power port is switched to the on state.

9. The apparatus of claim 8, wherein the code transmitted to turn the particular electronic device on is a mirror of the code received that turns the particular power port to the on state.

10. An apparatus comprising
a connection to a power source;
a plurality of power ports, each of the power ports switchable between an on state and an off state, wherein in an on state power from the power source is supplied to electronic equipment connected to a power port and in an off state power from the power source is not supplied to the electronic equipment connected to the power port;
a receiver, the apparatus operable therewith to receive a code from a remote control device and therewith switch each of the power ports individually between the on state and the off state;
a memory that stores codes for controlling a plurality of electronic devices and a delay associated with each of the plurality of electronic devices, and
a controller, the apparatus operable therewith to determine whether a code received from the remote control device is associated with a particular power port and to switch the particular power port from an on state to an off state a predetermined time after receiving the code from the remote control device according to the delay associated with the particular electronic device connected to the particular power port.

11. The apparatus of claim 10, wherein the code received is associated with a particular type of electronic device, and at least one of the power ports of the apparatus and the particular electronic device are both controlled with the code received.

12. The apparatus of claim 11, the controller operable to switch the particular power port to the on state in response to receiving the code for controlling the particular electronic device connected to the particular power port when at least one of the particular power port is in the off state and the particular electronic device connected to the particular power port is turned off.

13. The apparatus of claim 12, wherein the controller is operable to switch the power port to the on state with the code received.

14. The apparatus of claim 13, comprising a transmitter, the apparatus operable therewith to transmit a code to control the particular electronic device connected to the particular power port, wherein the controller is operable to transmit the code for controlling the particular electronic device and therewith turn the particular electronic device on a predetermined time after the particular power port is switched to the on state.

15. The apparatus of claim 14, wherein the code transmitted to turn the particular electronic device on is a mirror of the code received that turns the particular power port to the on state.

16. The apparatus of claim 11, wherein the receiver is remotely coupled to the apparatus.

17. The apparatus of claim 11, wherein the apparatus is operable to be programmed to control a plurality of electronic devices and a plurality of power ports in a programmed sequence.
